(19) United States
(12) Patent Application Publication
(10) Pub. No.: US 2002/0008879 A1
(43) Pub. Date: Jan. 24, 2002

(54) IMAGE PROCESSING METHOD

(76) Inventor: HIROYUKI MORIMATSU, FUKUOKA (JP)

Correspondence Address: LAWRENCE E ASHERY, RATNER & PRESTIA, SUITE 301 ONE WESTLAKES BERWYN, P O BOX 980, VALLEY FORGE, PA, 194820980

(21) Appl. No.: 09/195,390

(22) Filed: Nov. 18, 1998

(30) Foreign Application Priority Data
Nov. 18, 1997 (JP) 9-316778

(51) Int. Cl. G06K 15/02; G06T 5/00; H04N 1/405; H04N 1/409

(52) U.S. Cl. 358/1.9; 358/458; 382/237; 382/252; 382/266

(57) ABSTRACT

Binary coding is provided to a pixel of multi-grading to produce a bi-gradation image. Two adjacent pixels sandwiching a target pixel are determined. Then density differences between the target pixel and the respective adjacent pixels are found. When at least one of these differences exceeds a given value, the target pixel is considered to be part of the edge. When both of the differences are smaller than the given value, the target pixel is considered out of the edge. In the case of the target pixel belonging to the edge, a threshold value at the binary coding is set at a lower value than that of the case where the target pixel is out of the edge. Through the above procedure, an edge reproducibility of a bi-gradation image can be improved.

### FIELD OF THE INVENTION

The present invention relates to of the field of image processing applicable to printers, scanners, copying machines, facsimiles and the like, and more particularly to a method for reproducing multi-gradation image in a binary image.

### BACKGROUND OF THE INVENTION

The error-diffusion method is known as one of the methods converting a multi-gradation image into a bi-gradation image that displays gradation with a number of dots per unit area.

The principle of the error diffusion method is, in short, to retain a density of the image by diffusing respective pixel errors, which have been produced in binary coding, to the surrounding pixels.

The error diffusion method and its problems are described hereinafter.

FIG. 5 is a block diagram illustrating a circuit embodying a conventional error diffusion method.

In FIG. 5, multi-gradation data “D” of a target pixel to be binary coded is read into an image memory 100. The data “D” undergoes γ (gamma) correction by referring to the correction data stored in γ (gamma) correction ROM 101, and are corrected to produce multi-gradation data responsive to the printing characteristics of output devices such as printers and the like. An adder 102 of error diffusion processing unit 107 adds an error data “E” of this target pixel to the corrected multi-gradation data D′, then the adder 102 outputs F=D′+E.

Data “F” which included the error data of the target pixel is compared to a binary coded threshold value “Th” in a comparator 104. In the case of F≧Th, a binary signal B=“1” is tapped off, and in the case of F<Th, a binary signal B=“0” is tapped off. Based on this output, a binary coded error E′ produced in the binary coding is computed by a subtractor 106 as E′ =F−B′.

When the input data has 256 gradations (0-255), B′=B×255 is found. Therefore, e.g. in a case of input multi-gradation data D=230 and binary threshold value Th=128, the output data after binary coding is B=1, and thus the binary coded error is E=D−B×255=230−1×255 =−25.

This binary coded error E is weighted by a weighting error calculator 105 according to a given error matrix Mxy. The weighted error is then stored in an error memory 103 to be diffused into pixel data to be processed subsequently.

The weighted error data is added to the multi-gradation data of a subsequent pixel by adder 102 where the error data can be diffused.

In this example, when input multi-gradation data is D=230, the output data after binary coding is “1”, i.e. “255” of the 256 gradations resulting from the comparison of the input multi-gradation data with the binary coding threshold value Th=128. Thus, the error=25 is produced with regard to the input multi-gradation data D=230. As a result, the error=25 is a binary coded error of the input multi-gradation data D=230. This error is weighted by weighting error calculator 105 using an error matrix; is then diffused to error memory 103 to be reflected into subsequent binary coding of unprocessed pixels.

FIG. 6 shows an example of the error matrix Mxy employed in the conventional error diffusion method.

In FIG. 6, a present target pixel is marked with (*) symbol, and is given binary coding.

The error produced in the binary coding of this target pixel is weighted by weighting coefficients (7,1,5,3) shown in FIG. 6. The error is then diffused into the subsequent unprocessed pixel. The weighted error is stored in error memory 103 as an error distribution value. When the subsequent pixel is binary coded, the error distribution value stored in error memory 103 is read out, and the subsequent input value read out from the image memory 100 is corrected using this error distribution value.

As described above, according to the error diffusion method, a binary coded error, which is produced in a binary coding given to a pixel, is diffused (distributed) to subsequent pixel data to be binary coded. This method tries to minimize the error between the image data before and after the binary coding.

Considering the characteristics of the binary coding based on the error diffusion method, i.e. distributing the errors to the surrounding pixels, the processed image has a problem of reproducibility on its edge. In other words, part of the information about the surrounding pixels data having large difference values is added to the target pixel on the periphery of the edge portion, producing noise. As a result, the edge of the image is not well defined.

A conventional solution to this problem has been proposed. By reinforcing an edge through a bypass filter with regard to an original multi-grading data, the reproducibility of the edge is improved.

However, this solution has produced another problem, i.e. the filtering process negatively affects an entire image and lowers the image quality. Thus, the problem is not completely solved yet.

### SUMMARY OF THE INVENTION

The present invention addresses this problem and aims to provide an image processing method that can improve the reproducibility of the edges in a binary coded image, in particular, the edges in a binary coded image that has undergone an error diffusion process.

A method of image processing according to the present invention comprises the steps of:

(a) determining a target pixel;

(b) determining two adjacent pixels sandwiching the target pixel;

(c) computing differences of the density data between the target pixel and the respective adjacent pixels;

(d-1) determining the target pixel as a pixel on an edge when at least one of two differences of density data is greater than a given value, or

(d-2) determining the target pixel not to be a pixel on an edge when both the differences of density data are less than a given value.

When the target pixel is a pixel on an edge, a binary coding is given with a lower threshold value than that of when the target pixel is not a pixel on an edge. Through this arrangement, the probability that a binary- signal-output will appear “1 ” is increased. In other words, pixels on the edge are easy to produce dots in an output image. As a result, the edge in the output image can be clearly reproduced. That means, the reproducibility about the edges of binary images can be improved.

### BRIEF DESCRIPTION OF THE DRAWINGS

FIG. 1 is a block diagram illustrating a circuit diagram embodying an image processing method utilized in an exemplary embodiment of the present invention.

FIG. 2 is an illustrative drawing showing the pixels detected as a part of edge in an exemplary embodiment of the present invention.

FIGS. 3(a) and 3(b) are illustrative drawings showing the setting of a threshold value in a binary coding of the image processing method utilized in an exemplary embodiment of the present invention.

FIG. 4 is a flowchart depicting a process order according to the image processing method utilized in an exemplary embodiment of the present invention.

FIG. 5 is a block diagram of a circuit embodying a conventional method of error diffusion.

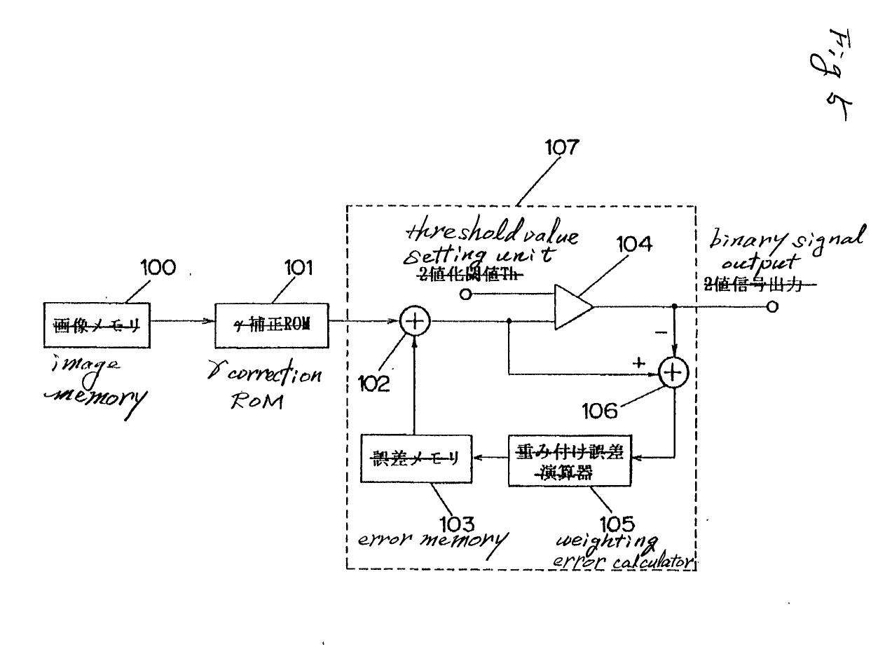

FIG. 6 is an illustrative drawing of an error matrix utilized in an exemplary embodiment of the present invention.

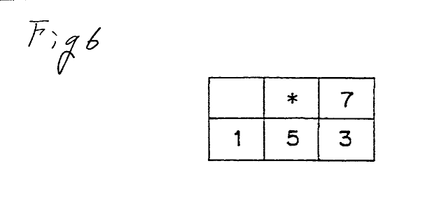

### DESCRIPTION OF THE PREFERRED EMBODIMENTS

An exemplary embodiment of the present invention is described hereinafter with reference to the accompanying drawings.

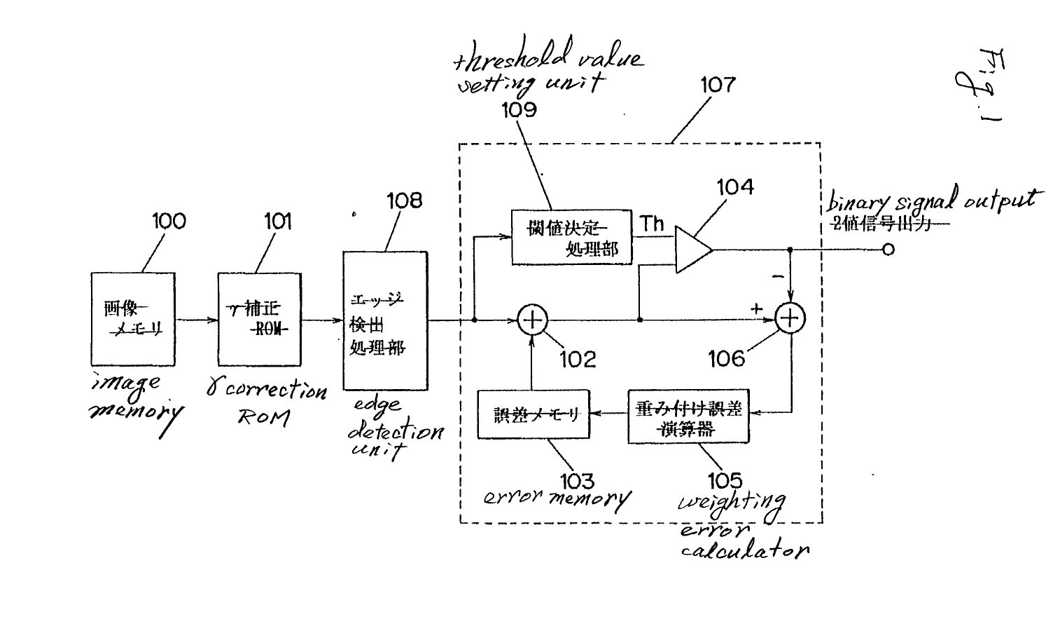

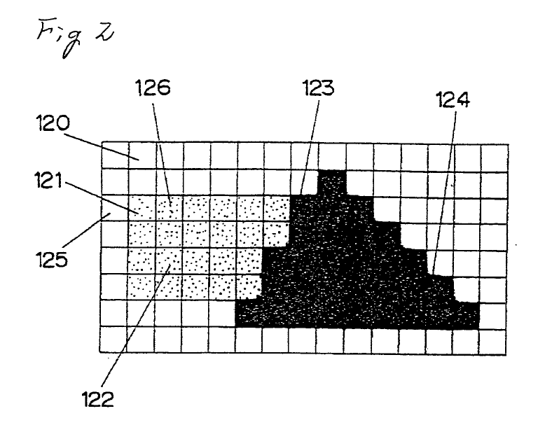

As shown in FIG. 1, the multi-gradation data “D” of a target pixel 121 shown in FIG. 2 is read into an image memory 100.

Then, the multi-gradation data D undergoes γ (gamma) correction by referring to correction data stored in γ (gamma) correction ROM 101. The corrected data can be responsive to printing characteristics of output devices such as printers.

The corrected multi-gradation data undergoes an edge detection process in edge detection unit 108 where target pixel 121 is detected and identified whether it belongs to an edge or not. Then, a threshold value is set in threshold setting unit 109 of error diffusion processing unit 107.

Adder 102 adds error data of target pixel 121 to the data of target pixel 121. The data of target pixel 121 is compared with the threshold set at setting unit 109 in comparator 104. As a result, a given binary signal is tapped off. Subtractor 106 computes a binary coded error produced at the binary coding by using this resultant output.

The binary coded error is weighted in weighting error calculator 105 according to a given error matrix Mxy. The weighted error is stored in error memory 103 to be distributed to subsequent non-processed pixels. In adder 102, the weighted error is added to the multi-gradation data of the pixel to be processed subsequently. Thus, the error is distributed.

Edge detection unit 108 detects whether target pixel 121 should belong to the edge or not when the target pixel 121 undergoes binary coding. Unit 108 outputs the information about this detection based on the multi-gradation data of adjacent pixels 125 and 126 positioned at the left and right of target pixel 121.

A detection procedure of the edge is described later.

When target pixel 121 is detected as part of the edge, threshold value setting unit 109 sets a threshold value for binary coding at a low value. This is for reproducing pixel 121 as part of the edge in an output image. This low threshold value allows a binary signal to prefer outputting “1” to “0”, i.e. dots are produced more frequently in an output image.

Detection and reproduction of the edge are described hereinafter with reference to FIG. 2.

FIG. 2 shows an image with pixel densities having multi-gradation data. The image in FIG. 2 undergoes binary coding. The density data indicating multi-gradation densities comprises 256 gradations (0-255). Assume the densities of the respective pixels are as follows.

Pixel 120 and adjacent pixel 125: density data=0;

Target pixel 121, pixel 122 and adjacent pixel 126: density data=128;

Pixels 123 and 124: density data=250

The pixels to be detected as part of the edge are, e.g. target pixel 121, pixels 123 and 124. In the image output after binary coding, these pixels must produce dots in order to reproduce the edge. Adjacent pixels 125 and 126 are positioned at the left and right side of target pixel 121. When the edge is detected, the densities of these adjacent pixels are referred to in order to figure out the density differences between target pixel 121 and the respective adjacent pixels 125 and 126.

The detection of whether target pixel 121 should belong to the edge or not is described here. Assume the respective pixels have the following density data.

Target pixel 121: D1, Adjacent pixel 125: D2, Adjacent pixel 126: D3,

Density difference between pixel 121 and pixel 125: DL,

Density difference between pixel 121 and pixel 126: DR

Then, DL=D1−D2, and

DR=D1-D3 are found.

When one of DL or DR exceeds a given value “S”, target pixel 121 is detected as part of the edge. In other words, when one of DL>S or DR>S is established, target pixel 121 is detected as a part of the edge.

The process after target pixel 121 is detected as a part of edge is described hereinafter.

The pixels detected as part of the edge must prefer outputting 1 as a binary signal responsive to respective density data so that the reproducibility of the edge can be improved (In other words, dots can be produced more frequently in the output image.) For realizing this preference, the threshold values at the binary coding of these pixels are varied so that the probability of outputting “1” can be increased, i.e. the probability of producing dots in the output image is raised.

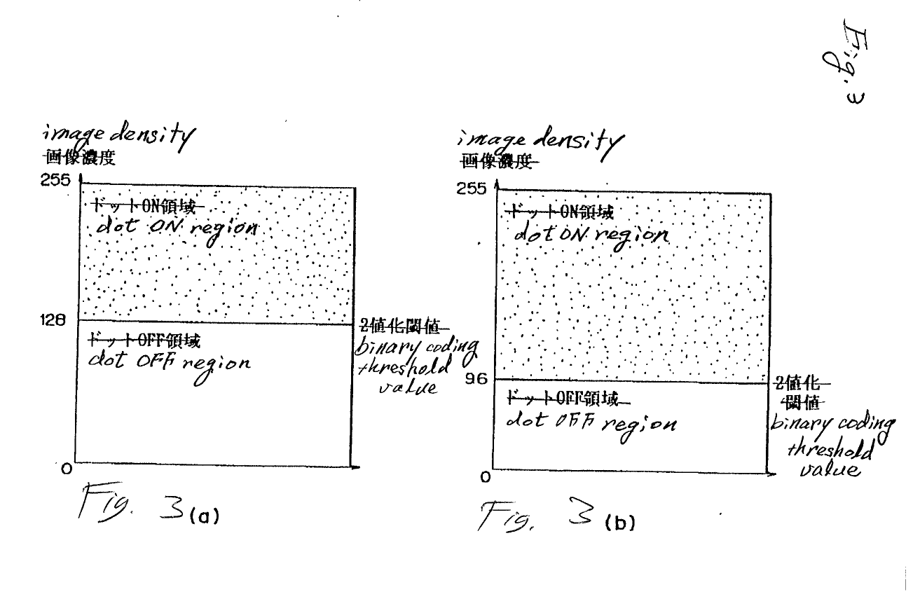

This process is detailed with reference to FIG. 3.

FIGS. 3(a) and 3(b) illustrate relations among the density data of an image, threshold values, and ON/OFF status of the dots.

In general, a binary coded threshold value, when it is binary coded through the conventional error diffusion method, is fixedly set at around 128th gradation, i.e. an intermediate value of an input density data having 256 gradations. However, in this exemplary embodiment, the binary coded threshold value of the pixel detected as the edge is lowered to, e.g. 96 so that the density data region, of which binary signal output is “1 ”, can be broadened. In other words, dots can be produced more frequently in this pixel on an output image. As a result, the reproducibility of the edge is improved.

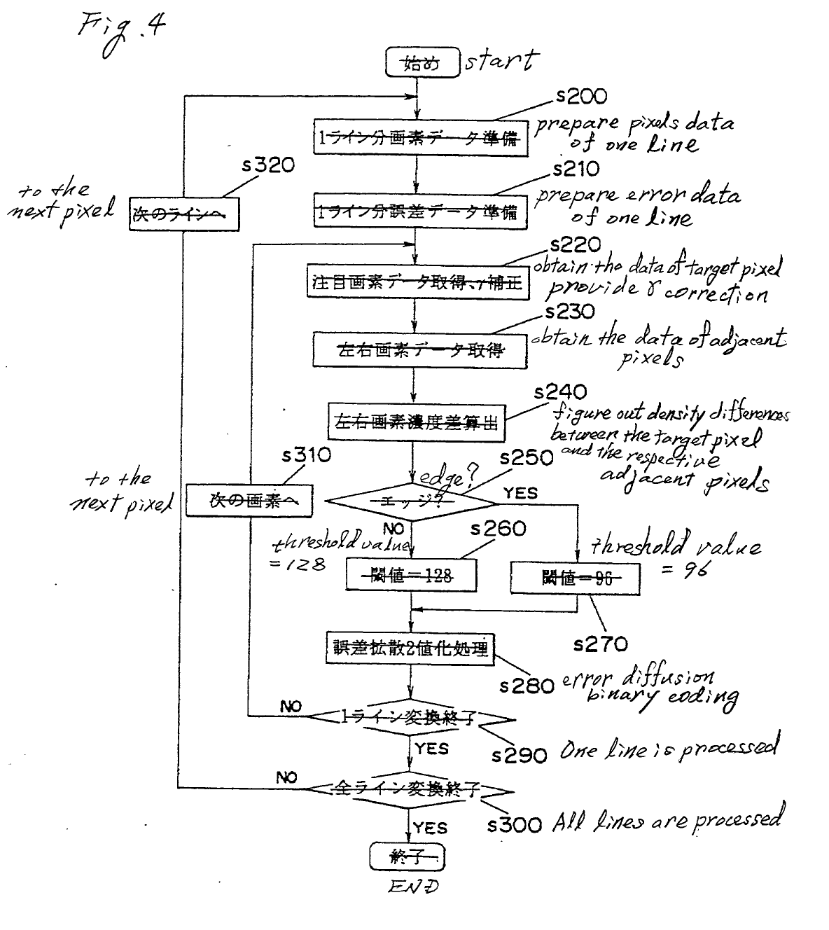

The above binary coding is detailed with reference to the flowchart shown in FIG. 4.

In FIG. 4, first, store one line data of multi-gradation data of the image to be binary coded into an image memory 100 (Step s200.)

Second, store the error data distributed to the pixels of this line into an error memory 103 (Step s210.)

Third, read out the density data D1 from the one line data, and obtain the data of target pixel 121. Then, refer to the data stored in γ (gamma) correction ROM 101, and provide a γ (gamma) correction to the data of the target pixel 121 (Step s220.)

Next, in the edge detection unit 108, obtain the density data D2 and D3 of the adjacent pixels of the target pixel 121 from the image memory 100 (Step s230.)

Figure out the difference of the density data of between the target pixel 121 and respective adjacent pixels, i.e. DL=D1−D2, and DR=D1−D3 (Step s240.)

Compare the density data differences DL and DR (Step s250.)

When either one of DL or DR is greater than the given value “S”, detect this pixel as a part of the edge in a threshold value setting unit 109, and set the threshold at a lower value, e.g. 96 (Step s270.)

When both of DL and DR are smaller than the given value “S”, detect this pixel as an outer part of the edge, and retain the threshold value at 128 (Step s260.)

After setting the threshold value as this, provide the binary coding to the target pixel 121 using the error diffusion method (Step s280.) This step completes the process on this pixel.

Finally, judge whether all the pixels on the present line have undergone the above process or not (Step s290.)

If the present line is not entirely processed, proceed to an unprocessed pixel (Step s310), and execute Steps s220-s280 to this pixel.

When the present line is entirely processed, judge whether all the lines have undergone the process or not (Step s300.)

If all the lines are not processed, proceed to an unprocessed line (Step s320.)

Repeat the above steps until all lines are processed.

As described above, this exemplary embodiment provides the following image processing.

(a) computing a difference of the density data between the target pixel and respective adjacent pixels;

(b) determining the target pixel as a pixel on an edge when at least one of two differences of density data is greater than a given value, or

(c) determining the target pixel not to be a pixel on the edge when both the differences of density data are less than a given value.

(d) When the target pixel is determined as a pixel on the edge, a binary coding is given with a lower threshold value than that of when the target pixel is not a pixel on the edge.

Through this arrangement, a binary-signal-output prefers to be “1 ”. In other words, pixels on the edge produce dots more frequently in an output image. As a result, the edge in the output image can be clearly reproduced. That means, the reproducibility about the edges of binary images can be improved.

In this exemplary embodiment, the adjacent pixels 125 and 126 are positioned at the left and right side of the target pixel 121; however, they can be on and beneath the target pixel. In other words, the adjacent pixels can be two pixels adjoining the target pixel and sandwich it.

The threshold values used in this exemplary embodiment are just the samples, and the threshold values are not limited to these samples.

Regarding an image processing apparatus, if the apparatus employed in the structure shown in FIG. 1 can perform the process described in FIG. 4, then this apparatus can be the image processing apparatus that has employed the bi-gradation image processing method described above.

The present invention can improve the reproducibility of the edge in bi-gradation image, i.e. the edge of an output image does not appear dim, but it appears outstandingly defined. When the error diffusion method is employed, in particular, the reproducibility of edges can be remarkably improved.

What is claimed is:

1. An image processing method for producing a bi-gradation image by providing binary coding to a plurality of pixels having multi-gradation, said method comprising the steps of:
(a) determining from said plurality of pixels a target pixel and two adjacent pixels sandwiching the target pixel;
(b) computing density data difference values between the target pixel and the respective adjacent pixels;
(c) determining the target pixel as one of i) being at an edge when at least one of the two difference values of density data is greater than a given value; and ii) being away from said edge when both the difference values of density data are less than said given value;
(d) providing binary coding to said target value based on whether the target pixel is at said edge or interior to said edge.

2. The method of claim 1, wherein binary coding includes an error diffusion method.

3. The method of claim 1, wherein the adjacent pixels are positioned horizontally at a left and a right side of the target pixel.

4. The method of claim 2, wherein the adjacent pixels are positioned horizontally at a left and a right side of the target pixel.

5. The method of claim 1, wherein the adjacent pixels are positioned vertically on and below the target pixel.

6. The method of claim 2, wherein the adjacent pixels are positioned vertically on and below the target pixel.

7. An image processing apparatus for performing binary coding to a plurality of pixels having multi-gradation comprising:means for determining from said plurality of said pixels a target pixel and two pixels adjacent sandwiching said target pixels;
means for computing density data difference values between the target pixel and the respective adjacent pixels;
means for determining whether the target pixel is at an edge based upon at least one of the two difference values of density data being greater than a given value;
means for determining that the target pixel is interior to said edge when both the difference values of density data are less than said given value; and
means for providing binary coding to said target value based on whether the target pixel is at said edge or interior to said edge.

8. An image processing apparatus according to claim 7, wherein said binary coding is performed using an error diffusion method.

9. An image processing apparatus according to claim 7, wherein the adjacent pixels are positioned horizontally at a left and a right side of the target pixel.

10. An image processing apparatus according to claim 8, wherein the adjacent pixels are positioned horizontally at a left and a right side of the target pixel.

11. An image processing apparatus according to claim 7, wherein the adjacent pixels are positioned vertically on and below the target pixel.

12. An image processing apparatus according to claim 8, wherein the adjacent pixels are positioned vertically on and below the target pixel.
